(19) United States
(12) Patent Application Publication
(10) Pub. No.: US 2006/0176478 A1
(43) Pub. Date: Aug. 10, 2006

(54) Raman spectroscopy with stabilized multi-mode lasers

(75) Inventors: Richard H. Clarke, Big Sky, MT (US); M. Edward Womble, Watertown, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: RAMAN SYSTEMS, INC., Lexington, MA (US)

(21) Appl. No.: 11/054,379

(22) Filed: Feb. 9, 2005

(51) Int. Cl. G01J 3/44; G01N 21/65

(52) U.S. Cl. 356/301

(57) ABSTRACT

Methods and apparatus for analysis of a sample using Raman spectroscopy, which employs a multi-mode radiation source and a spectral filter, are disclosed. The source radiation produces a Raman spectrum consisting of scattered electromagnetic radiation that is separated into different wavelength components by a dispersion element. A detection array detects a least some of the wavelength components of the scattered light and provides data to a processor for processing the data. The resulting spectroscopic data has higher resolution and stability than conventional low-resolution Raman systems.

### BACKGROUND OF THE INVENTION

The technical field of this invention is Raman spectroscopy and, in particular, the invention relates to improved resolution and stability of multi-mode lasers used in Raman spectroscopic systems.

It is known in the art that the chemical analysis of a sample containing organic components either as the main constituent (e.g., hydrocarbon fuels, solvent mixtures, organic process streams) or as a contaminant (e.g., in aqueous solutions) can be based upon optical spectrum analysis of that liquid. The optical spectral analysis used can be near infrared (IR) analysis, despite its inherent low resolution. Near IR chemical analysis systems use inexpensive light sources and detectors. In contrast, mid IR analysis provides easily identifiable spectra for many samples of interest. Mid IR provides a “fingerprint” spectral region having sharp detail. The sharp detail of the fingerprint spectral region makes subsequent analysis easier.

Raman spectroscopy provides many of the advantages of near IR. Raman spectroscopy can also provide detailed spectral analysis, typical of mid IR spectroscopy, for organic systems. However, one drawback to Raman spectroscopy has been its expense relative to mid and near infrared systems.

A significant component of that expense is the laser system required to produce quality, high-resolution spectra. Even using a laser diode as the scattering source, the laser remains one of the major expenses in developing cost-effective Raman systems.

U.S. Pat. No. 5,982,484 issued to Clarke et al., and incorporated herein by reference, teaches a low resolution Raman spectral analysis system for determining a constituent or a property of a sample. The system utilizes multi-mode lasers in making a Raman spectroscopic measurement of a sample.

While conventional low resolution Raman systems have proven useful, there remains room for a low cost, Raman spectroscopic systems that can provide spectroscopic measurements of improved resolution and/or stability.

### SUMMARY OF THE INVENTION

The present invention is directed to Raman spectroscopic systems that can inexpensively determine a constituent or a property of a sample at high resolution, without the use of an expensive, mode-locked radiation source, by employing a multi-mode laser source combined with a spectral filter. The filter narrows the emission wavelength of the radiation generated by the laser source and reduces mode hopping. This filtered radiation can be used to irradiate a sample and produce a Raman spectrum consisting of scattered electromagnetic radiation. The scattered radiation can then be measured to detect the constituents and/or properties of interest. The resulting Raman spectroscopic data has high resolution and stability.

In one aspect, the present invention provides an apparatus for measuring a property of a sample using a wide spectrum radiation source. The apparatus includes a multi-mode laser element, a volume phase grating, a dispersion element, a collection element, a detection array, and a processor. The volume phase grating limits the transmission of at least some unwanted wavelengths from a laser diode and thereby filters the source radiation. Downstream from the volume phase grating, the filtered source radiation irradiates a sample producing Raman spectrum composed of scattered electromagnetic radiation characterized by a particular distribution of wavelengths. The Raman spectrum is a result of the scattering of the laser radiation as it passes through a sample; the laser radiation is scattered as it interacts with the rotational and vibrational motion of the molecules of the sample.

The collection element collects the radiation scattered from the molecules of the sample and transmits the scattered radiation to the dispersion element. The collection element can be an optical fiber. The collection fiber can have a first end positioned for collecting scattered radiation, and a second end positioned in selected proximity to the dispersion element. A notch filter can be coupled to the first end of the collection fiber for filtering the excitation source background.

The dispersion element distributes the collected radiation into different wavelength components and the detection array detects the presence and/or intensity of the wavelength components. A processor can process the detected array data to detect the presence and/or quantity of a constituent of or to measure a property of the sample.

The resolution of the apparatus is determined in part by the full width at half maximum (FWHM) of the spectral distribution of the radiation exiting the radiation source/volume phase grating, and in part, by the dispersion element. In one embodiment, the apparatus has a spectral resolution better than about 10 cm⁻¹. In yet another embodiment, the apparatus has a spectral resolution better than about 6 cm⁻¹. In a further embodiment, the spectral resolution is in the range of about 4 cm⁻¹ and 10 cm⁻¹.

The apparatus can further include an optical waveguide, such as an optical fiber, for transmitting the laser radiation to the sample. The fiber can have a first end coupled to the volume phase grating and a second end immersed in a liquid sample or in proximity to a solid sample.

The apparatus can further include a sample chamber adapted to receive a sample. The sample chamber can include a filter element for filtering out, from the sample chamber's interior, light having wavelengths substantially similar to the light being detected. The filter element can also provide high transmisivity of light in the visible spectrum to allow visual observation of the second end of the excitation fiber. Thus, an operator can insure that the second end of the excitation fiber is substantially centered in the sample.

According to another embodiment, the multi-mode laser element produces laser radiation having a wavelength between about 700 nm and about 1 μm. The multi-mode laser preferably has a power between about 50 mw and about 1000 mw. One example of a multi-mode laser element for use with the present invention is a 785 nm GaAs laser diode. This GaAs multi-mode laser has a spectral distribution FWHM of greater than 2 nm⁻¹ without the volume phase grating.

According to other features of the present invention, the processor can include a chemometric element for applying partial least square analysis to extract additional information from the Raman spectrum. The dispersion element can be a low, medium, or high resolution spectrometer. In one aspect, the spectrometer can be a monochromator. The detection array can be a diode array detector. Alternatively, the detection array can be a noncooled charged coupled device detector. The collection fiber can include a fiberoptic immersion probe.

This invention is particularly useful in that it can provide a quick and reliable determination of a number of sample properties through a single spectral measurement on microliter samples. The present invention thus permits a chemical analysis to be determined without resort to an elaborate, multi-step analysis procedure requiring large quantities of sample.

In one illustrated embodiment, a low resolution, portable Raman spectrometer is disclosed. It can incorporate an immersible fiberoptic sensing probe, connected to a multi-mode laser diode, a volume phase grating positioned therebetween, a dispersion element and a diode array for spectral pattern detection. The diode array output can be analyzed through an integrated microprocessor system configured to provide output in the form of specific sample properties. The use of optical fibers, multi-mode laser diodes, a volume phase grating, a dispersion element, and diode arrays detectors allows the system to be small, portable, field-reliable, and sensitive to small amounts of constituents of interest. Furthermore, this configuration can provide an inexpensive device that would permit high resolution and continuous testing of the chemical components of an organic liquid.

The invention can also be used to monitor the properties of other hydrocarbon-containing samples, such as lubricating oils and the like. Typically, lubricating oils will experience changes in their hydrocarbon composition over time, and such changes are indicative of loss of lubricating efficiency. The apparatus of the present invention can be readily applied to monitor such changes.

In one aspect of the invention, the handheld Raman analyzer can provide information about multiple analytes. For example, the analytes can include blood components and/or metabolic products such as glucose, insulin, hemoglobin, cholesterol, electrolytes, antioxidants, nutrients, and/or blood gases. Other analytes that can be detected and/or monitored with the present invention include prescription or illicit drugs, alcohol, poisons, and disease markers.

### BRIEF DESCRIPTION OF THE DRAWINGS

The invention will be more fully understood from the following detailed description taken in conjunction with the accompanying drawings:

FIG. 1 is a schematic view of the Raman analyzer of the present invention; and

FIG. 2 is a graph of the Raman spectrum of o-xylene and m-xylene.

### DETAILED DESCRIPTION OF THE INVENTION

The terms “radiation”, “laser” and “light” are herein utilized interchangeably. In particular, these terms can refer to radiation having wavelength components that lie in the visible range of the electromagnetic spectrum, or outside the visible range, e.g., the infrared or ultraviolet range of the electromagnetic spectrum. In certain embodiments of Raman spectroscopy, the preferred excitation wavelengths will range from about 700 nanometers to 2.5 micrometers.

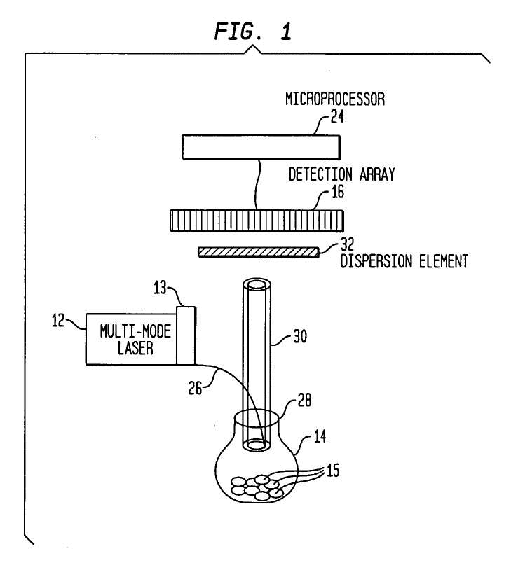

One embodiment of the Raman spectroscopy system 10 disclosed herein includes a multi-mode laser source connected to a spectral filter. The spectral filter narrows the wavelength range of the radiation delivered to a sample and ultimately improves the resolution and stability of Raman spectroscopy measurements made with the system. System 10 is schematically illustrated in FIG. 1, including multi-mode radiation source 12, spectral filter 13, and an excitation optical fiber 26 that carries the laser light to a sample chamber 14. Raman radiation scattered from the sample can be collected by a flexible optical fiber bundle 30 that is also optically coupled to the sample chamber 14. The fiber bundle 30 can be coated to reject the wavelength of the laser source light. The Raman scattered light travels through the fiber bundle 30 into a dispersion device 32, that serves to disperse the scattered light into its different wavelength components. The dispersed scattered light is detected by photodetector array 16 that, in this case, consists of a photodiode array or a charged-coupled device (CCD) array.

Radiation source 12 used with system 10 can include the variety of known solid state lasers conventionally used for Raman analysis. However, unlike conventional Raman systems, the use of radiation mode-locked radiation sources, with their severely controlled linewidths, is not required to achieve improved resolution and stability. In one embodiment, low cost, multi-mode Raman spectroscopy sources are used with system 10. Exemplary radiation sources can include, laser diodes producing laser radiation having a line width of at least 2 nanometers.

Exemplary low resolution laser sources that can be used with system 10 can include sources having higher power ranges (between about 50 mw and 1000 mw) compared with a traditional single mode laser (<150 milliwatts). The higher power of a multi-mode laser increases the amount of scattered radiation available to the spectrometer system and can further improve resolution. An exemplary radiation source is the B&W Tek multi-mode laser BWF-OEM-785-0.5, available from B&W Tek, Inc., of Newark, Del. Alternatively, the multi-mode laser can be a custom built.

The mode hopping and the wide spectral range of conventional multi-mode lasers have limited the ultimate resolution of conventional low resolution Raman systems. System 10 overcomes this lack of resolution by incorporating a spectral filter to narrow the line width and increase the stability of the radiation source. The spectral filter thus allows the use of a low cost, high-energy multi-mode laser where traditional low resolution Raman radiation source would provide insufficient resolution and/or stability.

In one embodiment, spectral filter 13 is a volume phase Bragg grating. Volume phase gratings are spectral filters that typically reflect light over a narrow wavelength range (e.g., about 0.05 to 0.5 nm), and transmit all other wavelengths. The narrow band reflected back to the laser cavity forces the diode to lase at the reflected wavelength determined by the volume phase grating. For example, the laser diode can transmit radiation through a collimating lens to the volume phase grating where a narrow band of radiation is reflected back the diode. The volume phase grating thus self-seeds the laser with the narrow band radiation and the laser produces radiation at the wavelength determined by the volume phase grating. Since the volume phase grating can be controlled with much better accuracy than the laser diode itself, the volume phase grating allow for improved control of the radiation produced. Exemplary volume phase gratings are available from various commercial sources including, for example, PD-LD, Inc. of Pennington, N.J.

The volume phase grating can lock and narrow the emission wavelength of the radiation so that radiation produced by high-powered laser diodes is transformed into narrow-band spectra with a precisely defined center wavelength (λc) and a very low sensitivity to temperature change. For example, a commercial multi-mode laser diode might produce radiation having a line width in the range of 3 to 6 nm, center wavelength control of +/−3 nm, and a change in wavelength with temperature (dλ/dT) of 0.3 nm/° C. However, with the volume phase grating the source radiation could have a line width of less that 0.5 nm, center wavelength control of +/−0.5 nm, and a change in wavelength with temperature (dλ/dT) of 0.01 nm/C. This improvement in resolution and stability ultimately provides improved spectroscopic data from system 10.

The use of the volume phase grating also simplifies system 10 by removing the need to carefully control the temperature of the radiation source. The emission wavelengths produced by high-powered laser diodes are temperature dependent and prior Raman systems relied on temperature control to produce radiation with the desired wavelength ranges. For example, thermoelectric coolers or water circulation system were used to provided temperature stability. However, the volume phase grating reduces the temperature dependence of the radiation wavelength and eliminates the need for such complicated temperature control systems.

The volume phase grating can also extend the useful lifetime of high-powered laser diodes by reducing the effect of wavelength shifts that occur with age. In particular, the increase in emission wavelength with aging known as the “red shift” is minimized by the use of the volume phase grating.

The volume phase grating improves the resolution of the system by narrowing the full width at half maximum (FWHM) of the spectral distribution of the source radiation. Raman measurements are based on the difference in wavelength between the scattered light and the excitation line, so an excitation line that has a smaller spectral FWHM causes less overlap in the wavelength of the emission radiation and the reflected radiation. This reduced overlap results in an increase in the resolution of the resulting Raman measurement.

The ultimate resolution of system 10 also depends on the characteristics of the dispersion element. The dispersion element divides the Raman radiation into different wavelengths segments. To increase resolution, the Raman radiation is divided into smaller segments. However, with low resolution Raman radiation, the Raman radiation cannot be finely divided. With the narrow band source radiation of system 10, however, the Raman radiation can be divided into smaller segments without degenerating the spectroscopic data.

In one embodiment, based on the spectral distribution of the source radiation and the dispersion element, system 10 has a spectral resolution better than about 10 cm⁻¹. In yet another embodiment, the apparatus has a spectral resolution better than about 6 cm⁻¹. In a further embodiment, the spectral resolution is in the range of about 4 cm⁻¹ and 10 cm⁻¹.

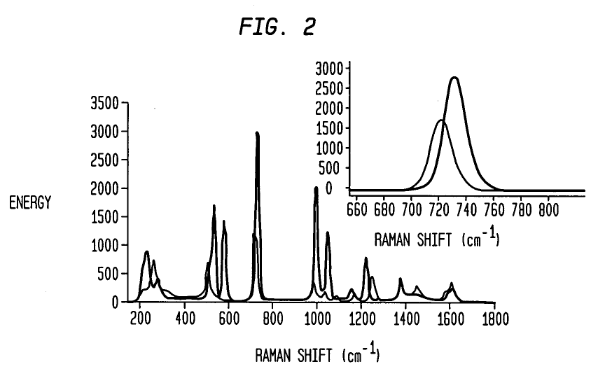

The resolution and stability of Raman spectra produced by system 10 was demonstrated by taking spectroscopic measurements of a solution containing o-xylene and m-xylene. The overlaid spectra of o-xylene and m-xylene are found in FIG. 2. As shown by the FIG., the resolution of the spectroscopic data allowed the m-xylene peak at 719 cm⁻¹ to be clearly discernable from the o-xylene peak at 728 cm⁻¹. This is an improvement in resolution compared to conventional multi-mode, low resolution Raman systems.

With respect to stability, the inset shows an overlay of repeated measurements of o- and m-xylene, recorded every 10 minutes, over a 12-hour period. Deviation in the peak location varied less than 1 cm⁻¹ and peak intensity varied less than 4%. Again, this is an improvement over conventional systems.

General background information on Raman spectral analysis can be found in U.S. Pat. Nos. 5,139,334, and 5,982,482 issued to Clarke et al. and incorporated herein by reference, which teach low resolution Raman analysis systems for determining certain properties related to hydrocarbon content of fluids. The system utilizes a Raman spectroscopic measurement of the hydrocarbon bands and relates specific band patterns to the property of interest. See also, U.S. Pat. No. 6,208,887 also issued to Clarke and incorporated herein by reference, which teaches a low-resolution Raman spectral analysis system for determining properties related to in vivo detection of samples based on a change in the Raman scattered radiation produced in the presence or absence of a lesion in a lumen of a subject. Additionally, commonly owned, pending U.S. application Ser. No. 10/367,238 entitled “Probe Assemblies for Raman Spectroscopy” and U.S. application Ser. No. 10/410,051 entitled “Raman Spectroscopic Monitoring of Hemodialysis” further describe devices for analyzing samples with Raman spectroscopy. All references cited herein are incorporated by reference in their entirety.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A Raman spectroscopy apparatus for measuring a property of a sample, the apparatus comprising:
a multi-mode laser for irradiating a sample to produce a Raman spectrum,
a grating positioned to receive and filter radiation from the multi-mode laser;
a dispersion element positioned to receive and separate scattered radiation into different wavelength components,
a detection array, optically aligned with the dispersion element for detecting at least some of the wavelength components of the scattered light, and
a processor for processing data from the detector array to measure a property of the sample,
wherein the apparatus provides a Raman spectrometer having a resolution of less than about 10 cm⁻¹.

2. The apparatus of claim 1, wherein the apparatus further comprises an excitation fiber for transmitting the laser radiation from the grating to the sample, the excitation fiber having a first end coupled to the grating and a second end positioned for interaction with the sample.

3. The apparatus of claim 2, wherein the apparatus further comprises a sample chamber adapted to receive a sample.

4. The apparatus of claim 1, wherein the grating is a volume phase Bragg grating.

5. The apparatus of claim 1, wherein the multi-mode laser produces laser radiation having a wavelength between about 700 nm and about 1 μm.

6. The apparatus of claim 1, wherein the multi-mode laser comprises a 785 nm GaAs laser diode.

7. The apparatus of claim 1, wherein the multi-mode laser has a full width at half maximum of at least about 2 nm without the volume phase grating.

8. The apparatus of claim 1, wherein the multi-mode laser has a power between about 50 mw and about 1000 mw.

9. The apparatus of claim 1, wherein the processor includes a chemometric means for applying partial least square analysis for extracting information from the Raman spectrum.

10. The apparatus of claim 1, wherein the detection array comprises a diode array detector.

11. The apparatus of claim 1, wherein the detection array comprises a charged coupled device detector.

12. The apparatus of claim 1, wherein the apparatus further comprises a collection fiber for collecting light scattered from a sample.

13. The apparatus of claim 1, wherein said apparatus has a resolution of between about 4 cm⁻¹ and 10 cm⁻¹, the resolution of the apparatus being determined in part by the volume phase grating and, in part, by the dispersion element.

14. A method for measuring a property of a sample using low resolution Raman spectroscopy comprising:
providing a sample;
producing radiation using a multi-mode laser;
passing the produced radiation through a grating that reduces mode-hopping effects and increase stability;
irradiating the sample to produce a Raman spectrum consisting of scattered electromagnetic radiation;
receiving and separating the scattered radiation into different wavelength components using a dispersion element;
detecting at least some of the wavelength components of the scattered light using a detection array; and
processing data from the detector array and calculating information about the sample with a processor.
